(19) United States
(12) Patent Application Publication
(10) Pub. No.: US 2024/0122159 A1
(43) Pub. Date: Apr. 18, 2024

(54) Pet Grooming Device and a Vacuum Cleaner Thereof

(71) Applicant: Ningbo Zhekai Electric Appliance Co., Ltd., Cixi City (CN)

(72) Inventors: Hairong Hu, Cixi City (CN); Zhangbin Xiao, Cixi City (CN); Youfeng Xu, Cixi City (CN)

(21) Appl. No.: 18/351,155

(22) Filed: Jul. 12, 2023

(30) Foreign Application Priority Data
Aug. 18, 2022 (CN) 202210991499.1
Mar. 10, 2023 (CN) 202310255745.1

(51) Int. Cl. A01K 13/00; A45D 27/00; A45D 44/00; A47L 5/36; A47L 7/00; A47L 9/12; A47L 9/14; A47L 9/22; A47L 9/24; A47L 9/28; A47L 9/32

(52) U.S. Cl. CPC A01K 13/002; A45D 27/00; A45D 44/00; A47L 5/362; A47L 7/0066; A47L 9/122; A47L 9/1409; A47L 9/1463; A47L 9/22; A47L 9/242; A47L 9/2857; A47L 9/327; A45D 2200/00

(57) ABSTRACT

A pet grooming device comprises a housing, a blade assembly, a motor, a switch, a rechargeable battery module, a hair suction duct; the hair suction duct is detachably disposed on the upper housing, the hair suction duct has an air inlet corresponding to the blade assembly; the housing has two strip-shaped slots arranged at a right side and a left side of a top of the housing, the housing has two strip-shaped ribs; and the hair suction duct has two extensions at the front end of the hair suction duct; each extension has a sliding groove at the inner wall of the extensions. The present invention also discloses a vacuum cleaner with the pet grooming device. The pet grooming device of the present invention is simple and reasonable in structure design, and easy to operate, assemble and disassemble.

### TECHNICAL FIELD OF THE INVENTION

The present invention relates to the field of pet supplies, to a pet grooming device and a vacuum cleaner thereof, and in particular to a portable pet grooming device with a prolonged battery life and a vacuum cleaner thereof.

### BACKGROUND OF THE INVENTION

Nowadays, many families keep pets, especially small animals such as cats and dogs. Pets bring much fun to people's life. However, the hair of cats and dogs is dense, short and soft, and easy to shed. Especially, the hair of pet cats sheds seriously in the season of molting. During trimming, the hair will fly up and scatter in the air or on the ground, which not only pollutes the environment, but also is easy to be inhaled into people's respiratory tract, causing sneezing and allergies. At present, there are many pet-specific grooming devices available in a market, which can collect the hair trimmed off while trimming hair. The pet grooming device is generally of a structure consisting of a main machine, a push button and a dust cup. The existing pet grooming device has the following defects in the use.
1, The pet grooming device is powered directly by wires inside a duct, and is not easy to operate due to the need of dragging the duct when in use.
2, The wiring in the duct is complicated and costly.
3, Due to the wiring in the duct, it is prone to safety accidents such as electric leakage once the duct is broken in use.
4, The pet grooming device powered by the lithium battery with a low capacity cannot operate for a long time in case of low battery, the battery needs to be charged, and the pet grooming device can operate only when the battery is fully charged, resulting in poor duration performance.

After searching, a Chinese Patent CN111360882A (patent NO: CN202010336336.0) disclosed a shaving device powered by a vacuum cleaner, which comprises a hair shaving component. The hair shaving component comprises a housing, a motor and a blade. The motor is mounted in the housing, and the blade is connected to the motor. An energized hose, with one end connected to a tail end of the housing and the other end thereof connected to an air inlet of the vacuum cleaner, is powered by the vacuum cleaner to supply power to the motor. In this structure, the energized hose is powered by the vacuum cleaner to supply power to the motor of the hair shaver. Therefore, there is also a problem of wiring in the hose, and another problem of short battery life. It is prone to safety accidents such as electric leakage once the hose is broken in use.

### SUMMARY OF THE INVENTION

It is a first object of the present invention to provide a pet grooming device which is reasonable in structure, safe and reliable in use, and easy for disassembly and charging.

It is a second object of the present invention to provide a vacuum cleaner with the pet grooming device.

For achieving the first object, the pet grooming device comprises a housing having an upper housing and a lower housing, a blade assembly, a motor, a switch, a rechargeable battery module, a hair suction duct having a front end and a rear end; wherein, the blade assembly, the motor, the switch and the rechargeable battery module are disposed inside the housing and connected to each other forming an electric clipper; the hair suction duct is detachably disposed on the upper housing along the lengthwise direction of the upper housing, the hair suction duct has an air inlet corresponding to the blade assembly at the front end of the hair suction duct and an air outlet connecting with a vacuum cleaner at the rear end of the hair suction duct; the housing has two strip-shaped slots arranged at a right side and a left side of a top of the housing, the housing has two strip-shaped ribs each located inside the corresponding strip-shaped slot adjacent to the top of the housing; and the hair suction duct has two extensions at the front end of the hair suction duct, each extension having an inner wall corresponding to the strip-shaped slots; each extension has a sliding groove at the inner wall of the extensions for receiving the corresponding strip-shaped rib, so that the hair suction duct is detachably connected to the housing; the extensions of the hair suction duct can move along the strip-shaped rib.

Preferably, the hair suction duct is a hollow cylinder with a U-shaped section, the hair suction duct has an opening at the front end, the rear end of the hair suction duct bends downward and extends backward to form a cylinder to connect to the housing, the hair suction duct is detachably disposed on the housing.

Preferably, a plurality of positioning strips are disposed transversely on a top surface of a front portion of the housing, correspondingly, the hair suction duct has a plurality of sockets located on a bottom surface of the front end of the hair suction duct and a plurality of entry guides in front of the sockets, easy for fixation and operation.

Preferably, the upper housing has a positioning portion protruding from the rear end of the upper housing, and the hair suction duct has a recess for receiving and positioning the positioning portion located at the rear end of the hair suction duct, easy for position.

Preferably, the hair suction duct is an arc in the lengthwise direction, having a bottom opening at the bottom of the hair suction duct, and an arc-shaped base plate is connected to the hair suction duct covering the bottom opening of the hair suction duct; and the hair suction duct is assembled by a plurality of components, so as to facilitate demolding in plastic molding and improve the hand feeling.

Preferably, a tube joint with a connecting clip is disposed at the rear end of the hair suction duct, the hair suction duct has a catching groove for receiving the connecting clip of the tube joint located on an outer surface of the rear portion of the hair suction duct.

Preferably, the rear end of the hair suction duct is a cylindrical structure for connecting to the tube joint, the catching groove is located at a bottom of the rear end of the hair suction duct; the tube joint has the connecting clip and a deck located at a bottom of the tube joint, the connecting clip is connected to a deck capable of swinging around a pin; and a spring is disposed between a rear side of the connecting clip and the deck, so as to urge the connecting clip upward to fasten the connecting clip with the catching groove; the tube joint is sleeved at the rear end of the hair suction duct and capable of connecting to the hair suction duct through the connecting clip connecting to the catching groove.

Preferably, the lower housing is a cylinder with a U-shaped section having an opening at a front end, a rear end and a top of the lower housing, and the rear end of the upper housing bending downward to connect to the rear end of the lower housing; the upper housing has a battery case arranged along the lengthwise direction on a top surface of the upper housing near the rear end of the upper housing, the rechargeable battery module has a charging pin centered on a front end of the rechargeable battery module, the battery case has a through hole for receiving the charging pin on an inner wall of a front end of the battery case; the rechargeable battery module is disposed inside the battery case, and the battery case has a plurality of necks located above the through hole on the inner walls of front and rear ends of the battery case, a cover plate with two snaps respectively extending from front and rear portions of the cover plate is connected to the upper housing and located inside the battery case when the snaps are positioned inside the respective necks.

Preferably, an opening at the front end of the lower housing is inclined downward and inward, the blade assembly comprises a fixed blade which is located at the opening at the front end of the lower housing through a fixed carrier, and an oscillating blade capable of oscillating from side to side against an inner side of the fixed blade through an oscillating carrier, and the oscillating carrier is in drive connection with a motor through a cam link; the lower housing comprises front and rear mounting cavities inside, the motor is disposed in the front mounting cavity of the lower housing, and a circuit board having a switch integrated on its lower end face is disposed below the rechargeable battery module in the rear mounting cavity, and a button switch and a USB interface connected to the circuit board are disposed on a lower surface of the lower housing.

Preferably, a plurality of fasteners are spaced on left and right sides of a front end of the upper housing, corresponding lugs are located on an inner wall of an upper end of the lower housing, and the lower housing and the upper housing are abutted by connecting the fasteners and the lugs for easy assembly and maintenance.

For achieving the second object, the vacuum cleaner having the pet grooming device comprises a main machine having a casing and a base, a vacuum cleaner motor for driving blades, a filter unit having a front end and a rear end, a dust cup detachably and horizontally disposed on the main machine and at the front end of the filter unit; wherein, the vacuum cleaner motor is disposed in the main machine, the dust cup and the filter unit are coaxially aligned with the vacuum cleaner motor; a mounting groove for receiving the casing and the dust cup is recessed on an upper surface of the base, the casing with an opening at a front end thereof is disposed at a rear position of the mounting groove of the base, and a motor support of the vacuum cleaner is disposed in the casing; the filter unit comprises a screen cover and an HEPA screen disposed at a front end of the motor support of the vacuum cleaner, the dust cup with an opening facing backward is disposed at a front portion of the mounting groove, and the screen cover with its upper end hinged to the dust cup and its lower end having a screen cover buckle for buckling to the dust cup, is covered at the opening of the dust cup.

As an improvement, an air inlet elbow, with its front end connected to the rear end of the pet grooming device through an air suction duct, is disposed at the front end of the base, an air inlet is located at a lower end of the dust cup, and a rear end of the air inlet elbow bents upward to communicate with the air inlet of the dust cup; a handle having a switch button thereon is disposed at an upper end of the casing, an air outlet lined with a filter and adsorption material layer is disposed at a lower end of the base, and an exhaust outlet communicated with the air outlet of the base is disposed at a lower end of the casing.

Preferably, the rear end of the hair suction duct is communicated with the vacuum cleaner through the air suction duct.

Compared with the prior art, the present invention has the following advantages. The pet grooming device has the lithium battery module therein and thus does not need to be powered by a main machine, which can avoid safety risks. The rechargeable battery module can be removed and easily replaced with a fully charged battery module for continuous service in case of low battery. The pet grooming device is capable of operating alone for pet grooming, and is connected to the hair suction duct to suck hair into the dust cup of the vacuum cleaner while grooming hair. The dust cup can be easily removed for routine cleaning. The external hair suction duct can be easily removed and cleaned to avoid the growth of bacteria.

The pet grooming device of the present invention is simple and reasonable in structure design, and easy to operate, assemble and disassemble, and can suck hair trimmed off into the dust cup of the vacuum cleaner while grooming hair to avoid hair flying in the environment. At the same time, the rechargeable battery module can be easily removed and replaced to provide a longer battery life in use, especially in the situation that the machine cannot operate continuously due to low battery when the family keeping many pets grooms pet hair for a long time.

### BRIEF DESCRIPTION OF THE DRAWINGS

FIG. 1 is a perspective view of a vacuum cleaner with a pet grooming device according to Embodiment 1 of the present invention;

FIG. 2 is a sectional view of the pet grooming device according to Embodiment 1 of the present invention;

FIG. 3 is an exploded view of the pet grooming device according to Embodiment 1 of the present invention;

FIG. 4 is an another exploded view of FIG. 3;

FIG. 5 is a perspective view of the pet grooming device according to Embodiment 2 of the present invention;

FIG. 6 is a first exploded view of the pet grooming device according to Embodiment 2 of the present invention;

FIG. 7 is a second exploded view of the pet grooming device according to Embodiment 2 of the present invention;

FIG. 8 is an another exploded view of FIG. 6.

### DETAILED DESCRIPTION OF THE INVENTION

The present invention will be further described below in detail by embodiments with reference to the accompanying drawings.

### Embodiment 1

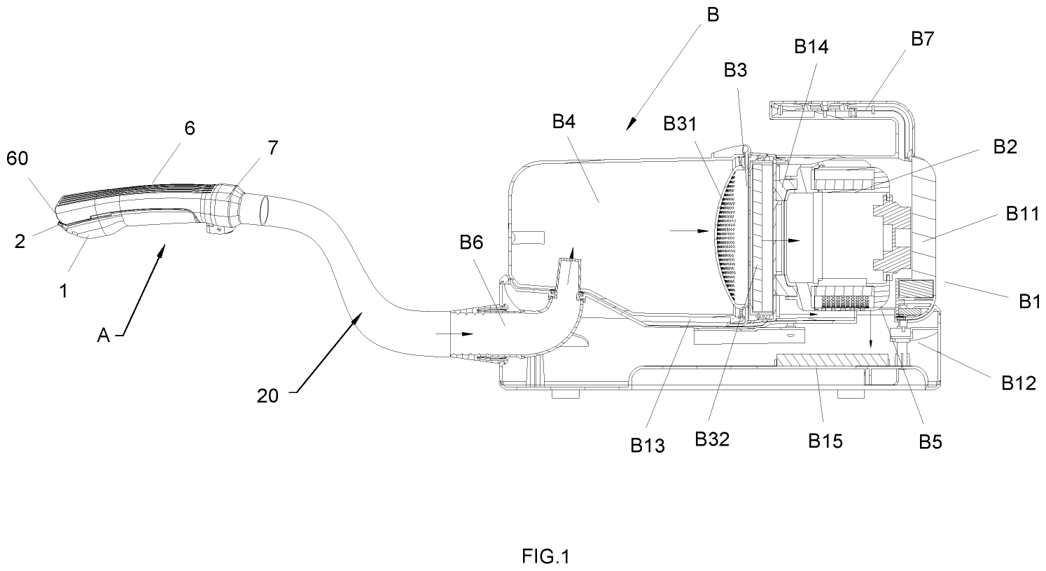

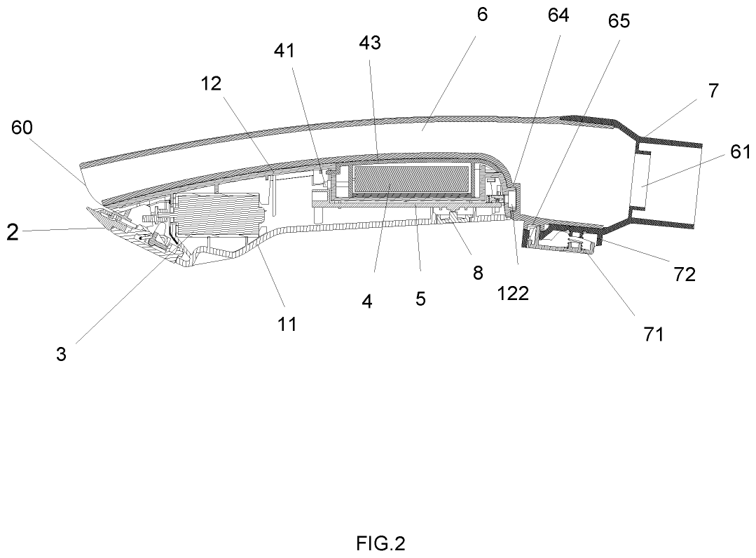

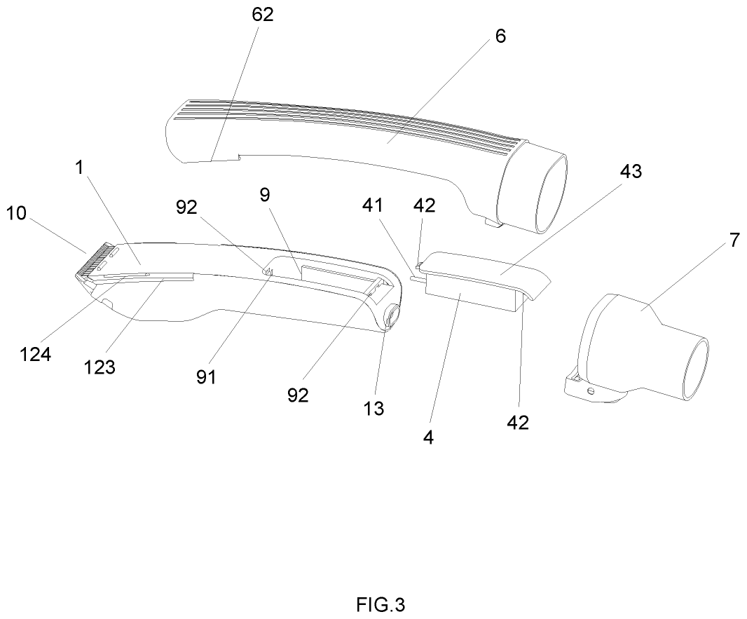

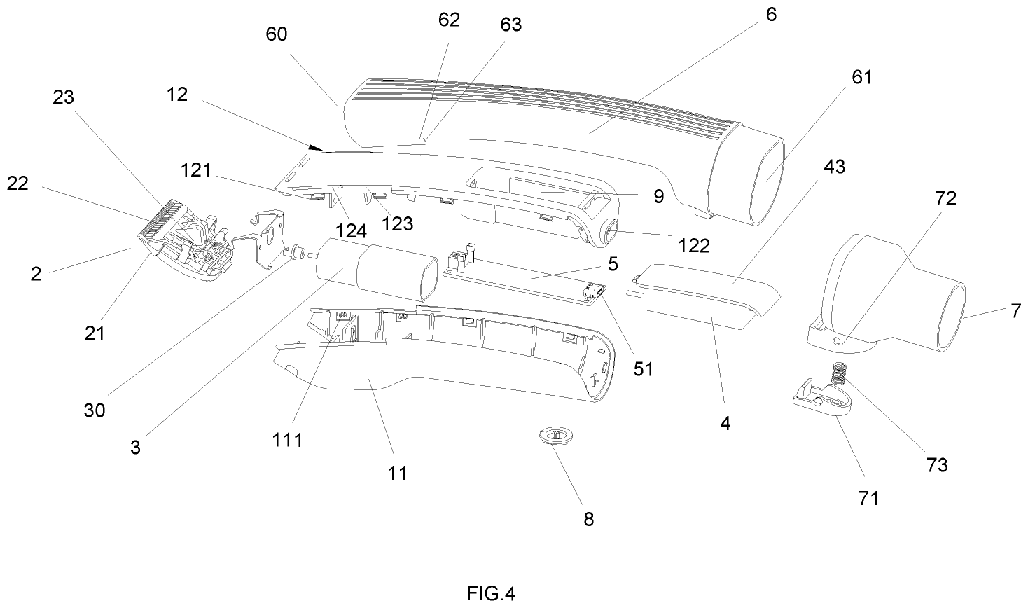

FIGS. 1-4 show a first preferred embodiment of the vacuum cleaner with the pet grooming device of the present invention. The portable pet grooming device comprises a housing 1 having an upper housing 12 and a lower housing 11, a blade assembly 2, a motor 3, a circuit board 5 and a rechargeable battery module 4 which is preferably a lithium battery module 4. The blade assembly 2, the motor 3, the circuit board 5 are disposed inside the housing 1 and connected to each other forming an electric clipper 10. The upper housing 12 has a battery case 9; the lithium battery module 4, having a cover plate 43 flush with the upper surface of the housing 1, is detachably disposed in the battery case 9 and electrically connected to the circuit board 5. A hair suction duct 6 is detachably disposed on the upper housing 12 along the lengthwise direction of the upper housing 12, the hair suction duct 6 has an air inlet 60 at the front end of the hair suction duct 6 and an air outlet 61 at the rear end of the hair suction duct 6, the rear end of the hair suction duct 6 is communicated with a vacuum cleaner B through an air suction duct 20.

A specific structure is as follows. The housing 1 comprises an upper housing 12 and a lower housing 11 which are abutted. The lower housing 11 is a cylinder with a U-shaped section having an opening at a front end, a rear end and a top of the lower housing 11, and the rear end of the upper housing 12 bending downward to connect to the rear end of the lower housing 11. The lower housing 11 and the upper housing 12 are connected as follows. A plurality of fasteners 121 are spaced on left and right sides of a front end of the upper housing 12, corresponding lugs 111 are located on an inner wall of an upper end of the lower housing 11, and the lower housing 11 and the upper housing 12 are abutted by connecting the fasteners 121 and the lugs 111. The upper housing 12 has a battery case 9 arranged along the lengthwise direction on a top surface of the upper housing 12 near the rear end of the upper housing 12, the lithium battery module 4 has a charging pin 41 centered on a front end of the rechargeable battery module 4, the battery case 9 has a through hole 91 for receiving the charging pin 41 on an inner wall of a front end of the battery case 9; the lithium battery module 4 is disposed inside the battery case 9, and the battery case 9 has a plurality of necks 92 located above the through hole 91 on the inner walls of front and rear ends of the battery case 9, the number of which depends on the need, a cover plate 43 with two snaps 42 respectively extending from front and rear portions of the cover plate 43 is connected to the upper housing 12 and located inside the battery case 9 when the snaps 42 are positioned inside the respective necks 92.

An opening at the front end of the lower housing 11 is inclined downward and inward, the blade assembly 2 comprises a fixed blade 21 which is located at the opening at the front end of the lower housing 11 through a fixed carrier, and an oscillating blade 22 capable of oscillating from side to side against an inner side of the fixed blade 21 through an oscillating carrier 23, and the oscillating carrier 23 is in drive connection with a motor 3 through a cam link 30; the lower housing 11 comprises front and rear mounting cavities inside, the motor 3 is disposed in the front mounting cavity of the lower housing 11, and a circuit board 5 having a switch 51 integrated on its lower end face is disposed below the rechargeable battery module 4 in the rear mounting cavity, and a button switch 8 and a USB interface 113 connected to the circuit board 5 are disposed on a lower surface of the lower housing 11.

The hair suction duct 6 is a hollow cylinder with a U-shaped section, the hair suction duct 6 has an opening at the front end, the rear end of the hair suction duct 6 bends downward and extends backward to form a cylinder to connect to the housing 1, the hair suction duct 6 is detachably disposed on the housing 1. A switch 51 with an USB interface 113 is connected to the circuit board 5, a corresponding charging port 122 in a positioning portion 13 is raised at the rear end of the upper housing 12, and a fixed recess 64 corresponding to the charging port 122 and fitted to the positioning portion 13 is disposed on an inner side of the rear end of the hair suction duct 6. The housing 1 has two strip-shaped slots 123 arranged at a right side and a left side of a top of the housing 1, the housing 1 has two strip-shaped ribs 124 each located inside the corresponding strip-shaped slot 123 adjacent to the top of the housing 1; and the hair suction duct 6 has two extensions 62 at the front end of the hair suction duct 6, each extension 62 having an inner wall corresponding to the strip-shaped slots 123; each extension 62 has a sliding groove 63 at the inner wall of the extensions 62 for receiving the corresponding strip-shaped rib 124, and the hair suction duct 6 is fitted to the charging port 122 through the fixed recess 64 at the rear end of the hair suction duct 6 and then fitted to the strip-type rib 124 through the sliding groove 63 for removable connection with the upper housing 11, so that the hair suction duct 6 is detachably connected to the housing 1. The rear end of the hair suction duct 6 is a cylindrical structure for connecting to the tube joint 7, the catching groove 65 is located at a bottom of the rear end of the hair suction duct 6; the tube joint 7 has the connecting clip 71 and a deck 72 located at a bottom of the tube joint 7, the connecting clip 71 is connected to a deck 72 capable of swinging around a pin; and a spring 73 is disposed between a rear side of the connecting clip 71 and the deck 72, so as to urge the connecting clip 71 upward to fasten the connecting clip 71 with the catching groove 65; the tube joint 7 is sleeved at the rear end of the hair suction duct 6 and capable of connecting to the hair suction duct 6 through the connecting clip 71 connecting to the catching groove 65.

The vacuum cleaner B with the portable pet grooming device comprises a main machine B1 having a casing B11 and a base B12, a vacuum cleaner motor B2 for driving blades, a filter unit B3 having a front end and a rear end, a dust cup B4 detachably and horizontally disposed on the main machine B1 and at the front end of the filter unit B3.

The vacuum cleaner motor B2 is disposed in the main machine B1, the dust cup B4 and the filter unit B3 are coaxially aligned with the vacuum cleaner motor B2; a mounting groove B13 for receiving the casing B11 and the dust cup B4 is recessed on an upper surface of the base B12, the casing B11 with an opening at a front end thereof is disposed at a rear position of the mounting groove B13 of the base B12, and a motor support B14 of the vacuum cleaner is disposed in the casing B11; the filter unit B3 comprises a screen cover B31 and an HEPA screen B32 disposed at a front end of the motor support B14 of the vacuum cleaner, the dust cup B4 with an opening facing backward is disposed at a front portion of the mounting groove B13, and the screen cover B31 with its upper end hinged to the dust cup B4 and its lower end having a screen cover buckle for buckling to the dust cup B4, is covered at the opening of the dust cup B4. An air inlet elbow B6, with its front end connected to the rear end of the pet grooming device through an air suction duct 20, is disposed at the front end of the base B12, an air inlet is located at a lower end of the dust cup B4, and a rear end of the air inlet elbow B6 bents upward to communicate with the air inlet of the dust cup B4; a handle B7 having a switch button thereon is disposed at an upper end of the casing B11, an air outlet B15 lined with a filter and adsorption material layer is disposed at a lower end of the base B12, and an exhaust outlet B5 communicated with the air outlet B15 of the base B12 is disposed at a lower end of the casing B11.

The technology of the wiring connection inside the vacuum cleaner B can be a prior art, which will not be described in details herein.

When in use, the hair trimmer A is connected to the vacuum cleaner B through the air suction duct 20, and the button switch 8 is pressed by hand for hair trimming. At the same time, when the button switch of the vacuum cleaner B is turned on, the vacuum cleaner B starts to work and generates negative pressure at the air inlet 60 of the hair trimmer A for hair suction since the air suction duct 20 is connected to the tail of the hair trimmer A. The hair trimmed off is sucked into the vacuum cleaner B through the hair suction duct 6 and the air suction duct 20, so that the hair can be sucked while being trimmed off, and is finally collected in the dust cup B4 to avoid hair flying in the environment.

After hair trimming, the dust cup B4 is removed and the screen cover B31 is opened, so that the dust cup 94 can be emptied out and cleaned easily.

In case of low battery, the hair suction duct 6 is removed, the lithium battery module 4 is taken out, and a charged lithium battery module 4 is loaded for long-term use, which allows easy operation and avoids the situation that the machine can be used again only after the battery is fully charged in the event that the battery runs out in use, especially the situation that the machine cannot operate continuously due to low battery when the family keeping many pets trims pet hair continuously or for a long time. In addition, the hair trimmer A has the lithium battery module 4 and thus does not need to be powered by the main machine, which can avoid safety risks.

The hair trimmer A may also be used alone.

### Embodiment 2

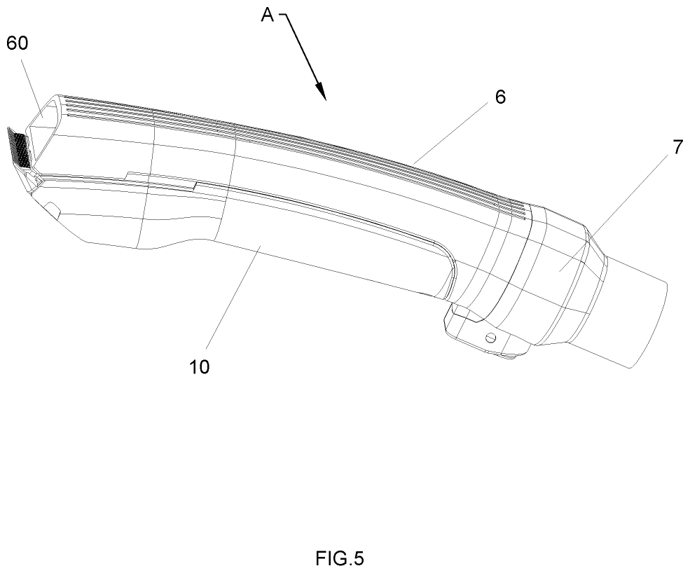

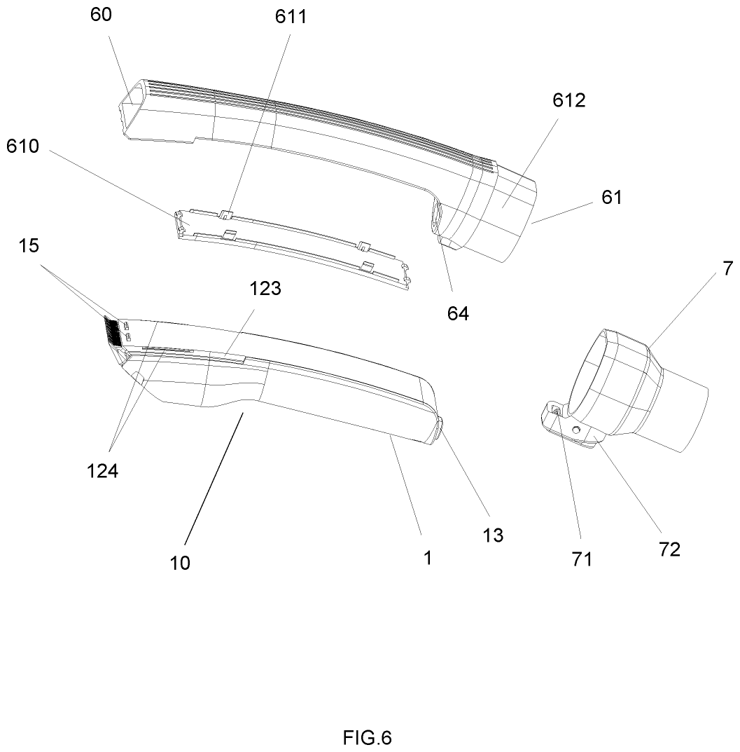

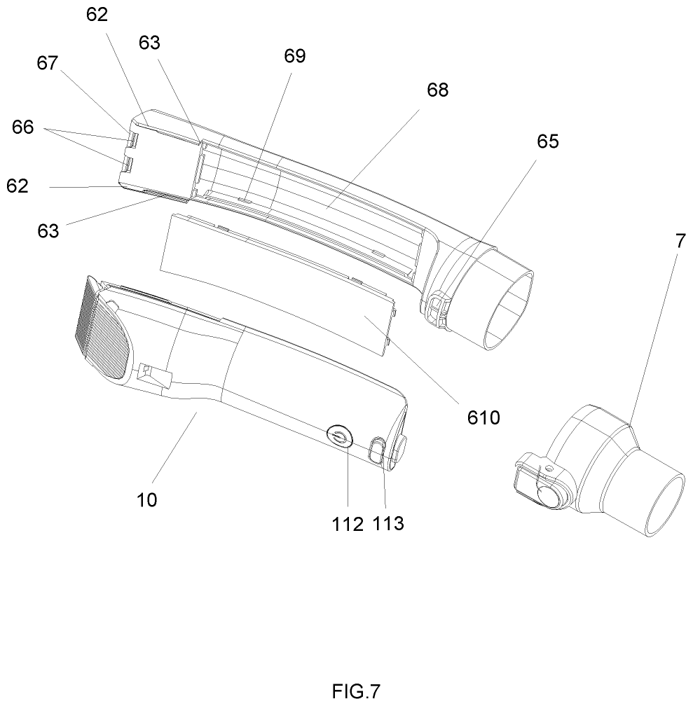

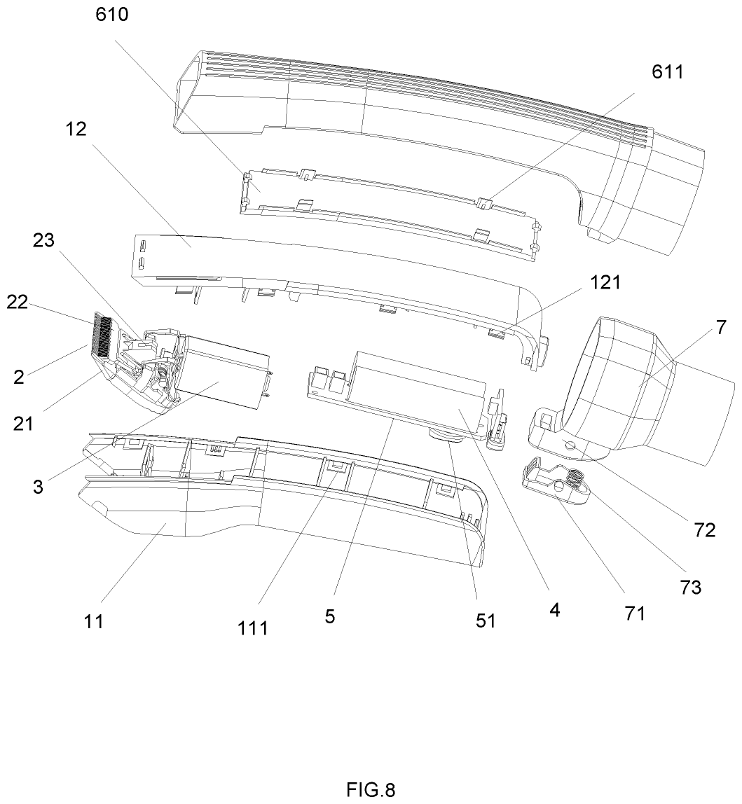

FIGS. 5-8 show a second preferred embodiment of the pet grooming device of the present invention. The portable pet grooming device comprises a hair trimmer A. The hair trimmer A comprises a housing 1 having an upper housing 12 and a lower housing 11, a blade assembly 2, a motor 3, a switch 51, a rechargeable battery module 4 which is preferably a lithium battery module 4, a circuit board 5. The blade assembly 2, the motor 3, the switch 51, the circuit board 5 are disposed inside the housing 1 and connected to each other forming an electric clipper 10. As the connection of the circuit board 5 is relatively simple, it may also be wiring connection instead. The hair suction duct 6 is detachably disposed on the upper housing 12 along the lengthwise direction of the upper housing 12, the hair suction duct 6 has an air inlet 60 at the front end of the hair suction duct 6 and an air outlet 61 at the rear end of the hair suction duct 6, the rear end of the hair suction duct 6 is communicated with a vacuum cleaner B through an air suction duct 20. The key point of the present invention lies in that the rear end of the hair suction duct 6 is a nozzle 612 with its middle-upper portion extending forward to form a tube with a flat cross section, so that a mounting face is formed at a front end of the nozzle 612, and mounting face has a fixed recess 64 which may be a circular recess with a gradually decreasing diameter and may also be an oval recess with a gradually shorter major axis/minor axis. The hair suction duct 6 has two extensions 62 at the front end of the hair suction duct 6, each extension 62 has a sliding groove 63 or necks 92 on the inner wall. Correspondingly, a positioning portion 13 fitted to the fixed recess 64 in shape and size is disposed at a rear portion of the housing 1 of the electric clipper 10, the housing 1 has two strip-shaped slots 123 arranged at a right side and a left side of a top of the housing 1, the housing 1 has two strip-shaped ribs 124 each located inside the corresponding strip-shaped slot 123 adjacent to the top of the housing 1. The fastening strips of the strip-shaped rib 124 are fitted to the sliding groove 63 or the necks 92 so that the hair suction duct 6 is abutted at the upper and rear ends of the housing 1 of the electric clipper 10, thereby achieving detachable connection with the housing 1 of the electric clipper 10.

In order to further position the electric clipper 10, a plurality of positioning strips 15 are disposed transversely on a top surface of a front portion of the housing 1, correspondingly, the hair suction duct 6 has a plurality of sockets 65 located on a bottom surface of the front end of the hair suction duct 6 for allowing an easy snap and a plurality of entry guides 66 in front of the sockets 65.

Usually, the hair suction duct 6 has an opening at the front end, the hair suction duct 6 is an arc in the lengthwise direction, which can be easily held by hand and more comfortable for use. The rear end of the hair suction duct 6 extends downward to form a nozzle 612 abutted at the rear end of the housing 1. The hair suction duct 6 has an inverted U-shaped or partially circular cross section and thus the cross section is flat. The hair suction duct 6 has a bottom opening 68, around which a plurality of bayonets 69 are distributed on an inner wall of the hair suction duct 6, at the bottom of the hair suction duct 6. An arc-shaped base plate 610 disposed in the lengthwise direction is fitted in size to the bottom opening 68 at the bottom of the hair suction duct 6, a plurality of clamping pins 611 fitted to the bayonets 69 are distributed on the base plate 610, so that the base plate 610 is connected at the bottom opening 68 to form the hair suction duct 6, thereby facilitating manufacturing and demolding the hair suction duct.

A tube joint 7 with a connecting clip 71 is disposed at the rear end of the hair suction duct 6, the hair suction duct 6 has a catching groove 65 for receiving the connecting clip 71 of the tube joint 7 located on an outer surface of the rear portion of the hair suction duct 6. Therefore, the rear end of the hair suction duct 6 is a cylindrical structure for connecting to the tube joint 7, the catching groove 65 is located at a bottom of the rear end of the hair suction duct 6; the tube joint 7 has the connecting clip 71 and a deck 72 located at a bottom of the tube joint 7, the connecting clip 71 is connected to a deck 72 capable of swinging around a pin; and a spring 73 is disposed between a rear side of the connecting clip 71 and the deck 72, so as to urge the connecting clip 71 upward to fasten the connecting clip 71 with the catching groove 65; the tube joint 7 is sleeved at the rear end of the hair suction duct 6 and capable of connecting to the hair suction duct 6 through the connecting clip 71 connecting to the catching groove 65.

A specific structure of the electric clipper 10 is as follows. The housing 1 comprises an upper housing 12 and a lower housing 11 which are abutted. The lower housing 11 is a cylinder with a U-shaped section having an opening at a front end, a rear end and a top of the lower housing 11, and the rear end of the upper housing 12 bending downward to connect to the rear end of the lower housing 11. A plurality of fasteners 121 are spaced on left and right sides of a front end of the upper housing 12, corresponding lugs 111 are located on an inner wall of an upper end of the lower housing 11, and the lower housing 11 and the upper housing 12 are abutted by connecting the fasteners 121 and the lugs 111. An opening at the front end of the lower housing 11 is inclined downward and inward, the blade assembly 2 comprises a fixed blade 21 which is located at the opening at the front end of the lower housing 11 through a fixed carrier, and an oscillating blade 22 capable of oscillating from side to side against an inner side of the fixed blade 21 through an oscillating carrier 23, and the oscillating carrier 23 is in drive connection with a motor 3 through a cam link 30; the lower housing 11 comprises front and rear mounting cavities inside, the motor 3 is disposed in the front mounting cavity of the lower housing 11, and a circuit board 5 having a switch 51 integrated on its lower end face is disposed below the lithium battery module 4 in the rear mounting cavity, a switch hole 112 and a USB interface 113, being fitted to the circuit board 5, are disposed on a lower surface of the lower housing 11, so as to facilitate the user to operate and control the electric clipper 10 and charging.

Other structures and methods of use are similar to those in Embodiment 1 of the pet grooming device.

The protection scope of the present invention is not limited to each embodiments described in this description. Any changes and replacements made on the basis of the scope of the present invention patent and of the description shall be included in the scope of the present invention patent.

1. A pet grooming device, comprising:
a housing having an upper housing and a lower housing;
a blade assembly;
a motor;
a switch;
a rechargeable battery module;
a hair suction duct having a front end and a rear end;
wherein,
the blade assembly, the motor, the switch and the rechargeable battery module are disposed inside the housing and connected to each other forming an electric clipper;
the hair suction duct is detachably disposed on the upper housing along the lengthwise direction of the upper housing, the hair suction duct has an air inlet corresponding to the blade assembly at the front end of the hair suction duct and an air outlet connecting with a vacuum cleaner at the rear end of the hair suction duct;
the housing has two strip-shaped slots arranged at a right side and a left side of a top of the housing, the housing has two strip-shaped ribs each located inside the corresponding strip-shaped slot adjacent to the top of the housing;
and the hair suction duct has two extensions at the front end of the hair suction duct, each extension having an inner wall corresponding to the strip-shaped slots;
each extension has a sliding groove at the inner wall of the extensions for receiving the corresponding strip-shaped rib, so that the hair suction duct is detachably connected to the housing;
the extensions of the hair suction duct can move along the strip-shaped rib.

2. The pet grooming device of claim 1, wherein the hair suction duct is a hollow cylinder with a U-shaped section, the hair suction duct has an opening at the front end, the rear end of the hair suction duct bends downward and extends backward to form a cylinder to connect to the housing, the hair suction duct is detachably disposed on the housing.

3. The pet grooming device of claim 1, wherein a plurality of positioning strips are disposed transversely on a top surface of a front portion of the housing, correspondingly, the hair suction duct has a plurality of sockets located on a bottom surface of the front end of the hair suction duct and a plurality of entry guides in front of the sockets.

4. The pet grooming device of claim 1, wherein the upper housing has a positioning portion protruding from the rear end of the upper housing, and the hair suction duct has a recess for receiving and positioning the positioning portion located at the rear end of the hair suction duct.

5. The pet grooming device of claim 1, wherein the hair suction duct is an arc in the lengthwise direction, having a bottom opening at the bottom of the hair suction duct, and an arc-shaped base plate is connected to the hair suction duct covering the bottom opening of the hair suction duct.

6. The pet grooming device of claim 1, wherein a tube joint with a connecting clip is disposed at the rear end of the hair suction duct, the hair suction duct has a catching groove for receiving the connecting clip of the tube joint located on an outer surface of the rear portion of the hair suction duct.

7. The pet grooming device of claim 6, wherein the rear end of the hair suction duct is a cylindrical structure for connecting to the tube joint, the catching groove is located at a bottom of the rear end of the hair suction duct;
the tube joint has the connecting clip and a deck located at a bottom of the tube joint, the connecting clip is connected to a deck capable of swinging around a pin;
and a spring is disposed between a rear side of the connecting clip and the deck, so as to urge the connecting clip upward to fasten the connecting clip with the catching groove;
the tube joint is sleeved at the rear end of the hair suction duct and capable of connecting to the hair suction duct through the connecting clip connecting to the catching groove.

8. The pet grooming device of claim 1, wherein the lower housing is a cylinder with a U-shaped section having an opening at a front end, a rear end and a top of the lower housing, and the rear end of the upper housing bending downward to connect to the rear end of the lower housing;
the upper housing has a battery case arranged along the lengthwise direction on a top surface of the upper housing near the rear end of the upper housing, the rechargeable battery module has a charging pin centered on a front end of the rechargeable battery module, the battery case has a through hole for receiving the charging pin on an inner wall of a front end of the battery case;
the rechargeable battery module is disposed inside the battery case, and the battery case has a plurality of necks located above the through hole on the inner walls of front and rear ends of the battery case, a cover plate with two snaps respectively extending from front and rear portions of the cover plate is connected to the upper housing and located inside the battery case when the snaps are positioned inside the respective necks.

9. The pet grooming device of claim 1, wherein an opening at the front end of the lower housing is inclined downward and inward, the blade assembly comprises a fixed blade which is located at the opening at the front end of the lower housing through a fixed carrier, and an oscillating blade capable of oscillating from side to side against an inner side of the fixed blade through an oscillating carrier, and the oscillating carrier is in drive connection with a motor through a cam link;
the lower housing comprises front and rear mounting cavities inside, the motor is disposed in the front mounting cavity of the lower housing, and a circuit board having a switch integrated on its lower end face is disposed below the rechargeable battery module in the rear mounting cavity, and a button switch and a USB interface connected to the circuit board are disposed on a lower surface of the lower housing.

10. The pet grooming device of claim 1, wherein a plurality of fasteners are spaced on left and right sides of a front end of the upper housing, corresponding lugs are located on an inner wall of an upper end of the lower housing, and the lower housing and the upper housing are abutted by connecting the fasteners and the lugs.

11. A vacuum cleaner with the pet grooming device of claim 1, comprising:
a main machine having a casing and a base;
a vacuum cleaner motor for driving blades;
a filter unit having a front end and a rear end;
a dust cup detachably and horizontally disposed on the main machine and at the front end of the filter unit;
wherein,
the vacuum cleaner motor is disposed in the main machine, the dust cup and the filter unit are coaxially aligned with the vacuum cleaner motor;
a mounting groove for receiving the casing and the dust cup is recessed on an upper surface of the base, the casing with an opening at a front end thereof is disposed at a rear position of the mounting groove of the base, and a motor support of the vacuum cleaner is disposed in the casing;
the filter unit comprises a screen cover and an HEPA screen disposed at a front end of the motor support of the vacuum cleaner, the dust cup with an opening facing backward is disposed at a front portion of the mounting groove, and the screen cover with its upper end hinged to the dust cup and its lower end having a screen cover buckle for buckling to the dust cup, is covered at the opening of the dust cup.

12. The vacuum cleaner of claim 11, wherein an air inlet elbow, with its front end connected to the rear end of the pet grooming device through an air suction duct, is disposed at the front end of the base, an air inlet is located at a lower end of the dust cup, and a rear end of the air inlet elbow bents upward to communicate with the air inlet of the dust cup;
a handle having a switch button thereon is disposed at an upper end of the casing, an air outlet lined with a filter and adsorption material layer is disposed at a lower end of the base, and an exhaust outlet communicated with the air outlet of the base is disposed at a lower end of the casing.

13. The vacuum cleaner of claim 11, wherein the rear end of the hair suction duct is communicated with the vacuum cleaner through the air suction duct.
